(19) United States
(12) Patent Application Publication
(10) Pub. No.: US 2014/0333828 A1
(43) Pub. Date: Nov. 13, 2014

(54) PORTABLE CAMERA DOCK

(71) Applicant: Microsoft Corporation, Redmond, WA (US)

(72) Inventors: Amy Aimei Han, Portola Valley, CA (US); Jason Williams, Santa Clara, CA (US)

(21) Appl. No.: 13/892,085

(22) Filed: May 10, 2013

(51) Int. Cl. H04N 5/225; H04N 1/00

(52) U.S. Cl. CPC H04N 5/225; H04N 1/00127
USPC 348/373

(57) ABSTRACT

A portable camera dock is configured to receive a camera and enable data to be transferred between the camera and another device connected to the portable camera dock. The portable camera dock can also enable the camera to be recharged. Further, the portable camera dock can include mounting structure to enable the portable camera dock to be mounted to other structures to facilitate portability of a camera docked to the camera dock.

### BACKGROUND

As consumer electronic devices, such as cameras, evolve, the industry desire to improve and enhance the user experience continues to present design challenges to those who design and sell such devices.

### SUMMARY

This Summary is provided to introduce a selection of concepts in a simplified form that are further described below in the Detailed Description. This Summary is not intended to identify key features or essential features of the claimed subject matter.

Various embodiments provide a portable camera dock that is configured to receive a camera. The portable camera dock can enable data to be transferred between the camera and another device connected to the portable camera dock. Alternately or additionally, the portable camera dock can enable the camera to be recharged.

The portable camera dock includes electronic structure to enable functional connections between a suitably-configured camera and the portable camera dock. The electronic structure can serve to enable one or both of information transfer to and from the camera, and recharging of the camera. Further, the portable camera dock can include mounting structure to enable the portable camera dock to be mounted to other structures to facilitate portability of a camera docked to the camera dock.

The portable camera dock is designed in such a way so as to ease the transition between a camera's “plugged in” state (e.g., for information transfer or recharging) and a wireless state in which the camera is not plugged in to another device.

### BRIEF DESCRIPTION OF THE DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 is an example camera device in accordance with one or more embodiments.

FIG. 2 illustrates an example camera device in accordance with one or more embodiments.

FIG. 3 illustrates an example camera device in accordance with one or more embodiments.

FIG. 4 is a flow diagram that describes steps in a method in accordance with one or more embodiments.

FIG. 5 is a flow diagram that describes steps in a method in accordance with one or more embodiments.

FIG. 6 is a flow diagram that describes steps in a method in accordance with one or more embodiments.

FIGS. 7A and 7B illustrate a portable camera dock in accordance with one embodiment.

FIGS. 8A and 8B illustrate a portable camera dock in accordance with one embodiment.

FIGS. 9A and 9B illustrate a portable camera dock in accordance with one embodiment.

FIGS. 10A and 10B illustrate a portable camera dock in accordance with one embodiment.

FIG. 11 illustrates the portable camera dock with a camera docked thereon.

### DETAILED DESCRIPTION

Overview

Various embodiments provide a portable camera dock that is configured to receive a camera. The portable camera dock can enable data to be transferred between the camera and another device connected to the portable camera dock. Alternately or additionally, the portable camera dock can enable the camera to be recharged.

The portable camera dock includes electronic structure to enable functional connections between a suitably-configured camera and the portable camera dock. The electronic structure can serve to enable one or both of information transfer to and from the camera, and recharging of the camera. Further, the portable camera dock can include mounting structure to enable the portable camera dock to be mounted to other structures to facilitate portability of a camera docked to the camera dock.

The portable camera dock is designed in such a way so as to ease the transition between a camera's “plugged in” state (e.g., for information transfer or recharging) and a wireless state in which the camera is not plugged in to another device.

The portable camera dock can be utilized in connection with any suitably-configured camera. One such example of a camera is a wearable camera. The wearable camera is mountable on a user's clothing. The camera is designed to be unobtrusive and user-friendly insofar as being mounted away from the user's face so as not to interfere with their view. In at least some embodiments, the camera includes a housing and a clip mounted to the housing to enable the camera to be clipped onto the user's clothing. The camera is designed to be lightweight with its weight balanced in a manner that is toward the user when clipped to the user's clothing.

In one or more embodiments, the camera includes a replay mode. When the replay mode is selected, the camera automatically captures image data, such as video or still images, and saves the image data to a memory buffer. In at least some embodiments, the size of the memory buffer can be set by the user to determine how much image data is to be collected. Once the memory buffer is full, the older image data is erased to make room for currently-captured image data. If an event occurs that the user wishes to memorialize through video or still images, a record button can be activated which saves the image data from the beginning of the memory buffer and continues recording until the user presses the record button again. In this manner, if an event occurs, the user is assured of capturing the event from a time t−x, where x is the length of the memory buffer, in time.

In the discussion that follows, a section entitled “Example Environment” describes an example environment in which the various embodiments can be utilized. Next, a section entitled “Replay Functionality” describes an example replay mode in accordance with one or more embodiments. Following this, a section entitled “Duel Encoding” describes an embodiment in which captured image data can be dual encoded in accordance with one or more embodiments. Next, a section entitled “Photo Log” describes an example photo log in accordance with one or more embodiments. Following This, a Section Entitled “Portable Camera Dock” describes various embodiments that can be utilized with the wearable camera described herein, as well as with other types of cameras which may not necessarily be wearable.

Consider now an example environment in which various embodiments can be practiced.

Example Environment

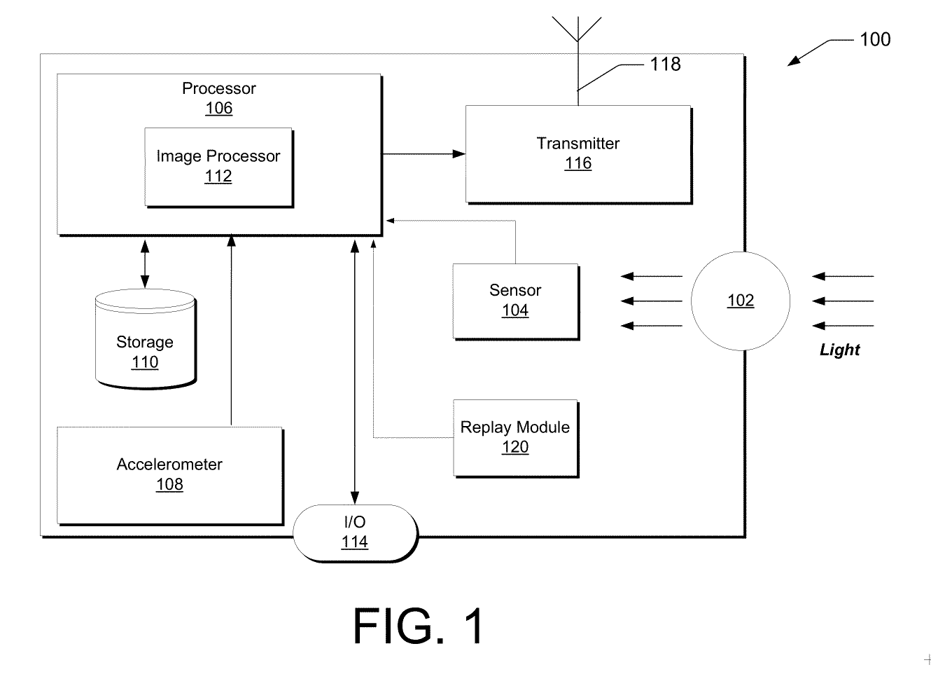

FIG. 1 illustrates a schematic of a camera device 100 in accordance with one or more embodiments. The camera device 100 includes a lens 102 having a focal length that is suitable for covering a scene to be pictured. In one embodiment, a mechanical device may be included with the lens 102 to enable auto or manual focusing of the lens. In another embodiment, the camera device 100 may be a fixed focus device in which no mechanical assembly is included to move the lens 102. A sensor 104 having a sensing surface (not shown) is also included to convert an image formed by the incoming light on the sensing surface of the sensor 104 into a digital format. The sensor 104 may include a charge-coupled device (CCD) or complementary metal oxide semiconductor (CMOS) image sensor for scanning the incoming light and creating a digital picture. Other technologies or devices may be used so long as the used device is capable of converting an image formed by the incoming light on a sensing surface into the digital form. Typically, these image detection devices determine the effects of light on tiny light sensitive devices and record the changes in a digital format.

It should be appreciated that the camera device 100 may include other components such as a battery or power source and other processor components that are required for a processor to operate. However, to avoid obfuscating the teachings, these well-known components are being omitted. In one embodiment, the camera device 100 does not include a view finder or a preview display. In other embodiments, however, a preview display may be provided. The techniques described herein can be used in any type of camera, and are particularly effective in small, highly portable cameras, such as those implemented in mobile telephones and other portable user equipment. Thus, in one embodiment, the camera device 100 includes hardware or software for making and receiving phone calls. Alternately, the camera device 100 can be a dedicated, stand-alone camera.

In at least some embodiments, the camera device 100 further includes an accelerometer 108. The accelerometer 108 is used for determining the direction of gravity and acceleration in any direction. Further included is an input/output (I/O) port 114 for connecting the camera device 100 to an external device, including a general purpose computer. In various embodiments, the I/O port can be used to connect to a portable camera dock such as the one described in detail below. The I/O port 114 may be used for enabling the external device to configure the camera device 100 or to upload/download data. In one embodiment, the I/O port 114 may also be used for streaming video or pictures from the camera device 100 to the external device. In one embodiment, the I/O port may also be used for powering the camera device 100 or charging a rechargeable battery (not shown) in the camera device 100. Connection to the portable camera dock can be made through any suitably-configured electronic structure, an example of which is provided below.

The camera device 100 may also include an antenna 118 that is coupled to a transmitter/receiver (Tx/Rx) module 116. The Tx/Rx module 116 is coupled to a processor 106. The antenna 118 may be fully or partly exposed outside the body of the camera device 100. However, in another embodiment, the antenna 118 may be fully encapsulated within the body of the camera device 100. The Tx/Rx module 116 may be configured for Wi-Fi transmission/reception, Bluetooth transmission/reception or both. In another embodiment, the Tx/Rx module 116 may be configured to use a proprietary protocol for transmission/reception of the radio signals. In yet another embodiment, any radio transmission or data transmission standard may be used so long as the used standard is capable of transmitting/receiving digital data and control signals. In one embodiment, the Tx/Rx module 116 is a low power module with a transmission range of less than ten feet. In another embodiment, the Tx/Rx module 116 is a low power module with a transmission range of less than five feet. In other embodiments, the transmission range may be configurable using control signals received by the camera device 100 either via the I/O port 114 or via the antenna 118.

The camera device 100 further includes a processor 106. The processor 106 is coupled to the sensor that 104 and the accelerometer 108. The processor 106 may also be coupled to storage 110, which, in one embodiment, is external to the processor 106. The storage 110 may be used for storing programming instructions for controlling and operating other components of the camera device 100. The storage 110 may also be used for storing captured media (e.g., pictures and/or videos). In another embodiment, the storage 110 may be a part of the processor 106 itself.

In one embodiment, the processor 106 may optionally include an image processor 112. The image processor 112 may be a hardware component or may also be a software module that is executed by the processor 106. It may be noted that the processor 106 and/or the image processor 112 may reside in different chips. For example, multiple chips may be used to implement the processor 106. In one example, the image processor 112 may be a Digital Signal Processor (DSP). The image processor can be configured as a processing module, that is a computer program executable by a processor. The processor 112 is used to process a raw image received from the sensor 104 based on the input received from the accelerometer 108. Other components such as Image Signal Processor (ISP) may be used for image processing. In one embodiment, the storage 110 is configured to store both raw (unmodified image) and the corresponding modified image. In one or more embodiments, the storage 110 can include a memory buffer, such as a flash memory buffer, that can be used as a circular buffer to facilitate capturing image data when the camera is set to a replay mode that is supported by replay module 120. The replay module 120 can be implemented in connection with any suitable hardware, software, firmware, or combination thereof. When the replay mode is selected, the camera automatically captures image data, such as video or still images, and saves the image data to the memory buffer. In at least some embodiments, the size of the memory buffer can be set by the user to determine how much image data is to be collected. If an event occurs that the user wishes to memorialize through video or still images, a record button can be activated which saves the image data from the beginning of the memory buffer and continues recording until the user presses the record button again. In this manner, if an event occurs, the user is assured of capturing the event from a time t−x, where x is the length of the memory buffer, in time.

A processor buffer (not shown) may also be used to store the image data. The pictures can be downloaded to the external device via the I/O port 114 or via the wireless channels using the antenna 118. In one embodiment, both unmodified and modified images are downloaded to the external device when the external device sends a command to download images from the camera device 110. In one embodiment, the camera device 100 may be configured to start capturing a series of images at a selected interval

In one embodiment, a raw image from the sensor 104 is inputted to an image processor (such as an ISP) for image or color correction. In one example embodiment, an image rotation mechanism described in U.S. patent application Ser. No. 13/754,719, filed Jan. 30, 2013 and incorporated by reference herein, is applied to the image outputted by the image processor. In other embodiments, the image rotation mechanism may be applied to the raw image received from the sensor 104. After the image rotation mechanism is applied to the image outputted by the image processor, the modified image is encoded. The image encoding is typically performed to compress the image data.

In another embodiment, the camera device 100 processes the raw image through an image processor (such as an ISP) and then transmits the processed image to a cloud based image processing/storage system.

In one embodiment, the native image processing system in the camera device 100 may produce images and/or videos in a non-standard format. For example, a 1200×1500 pixel image may be produced. This may be done by cropping, scaling, or using an image sensor with a non-standard resolution. Since methods for transforming images in a selected standard resolution are well-known, there will be no further discussion on this topic.

Various embodiments described above and below can be implemented utilizing a computer-readable storage medium that includes instructions that enable a processing unit to implement one or more aspects of the disclosed methods as well as a system configured to implement one or more aspects of the disclosed methods. By “computer-readable storage medium” is meant all statutory forms of media. Accordingly, non-statutory forms of media such as carrier waves and signals per se are not intended to be covered by the term “computer-readable storage medium”.

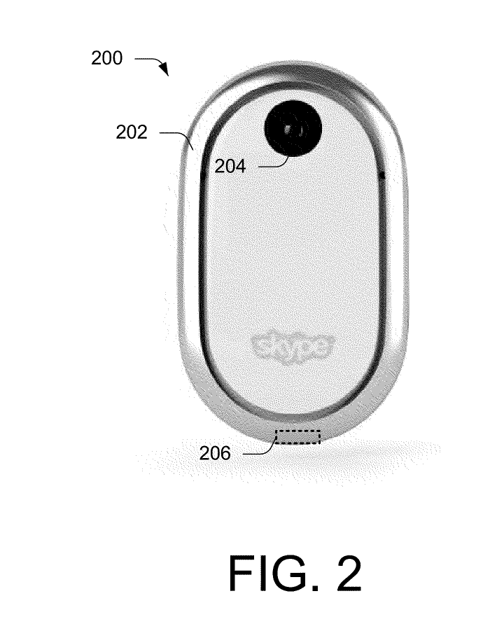

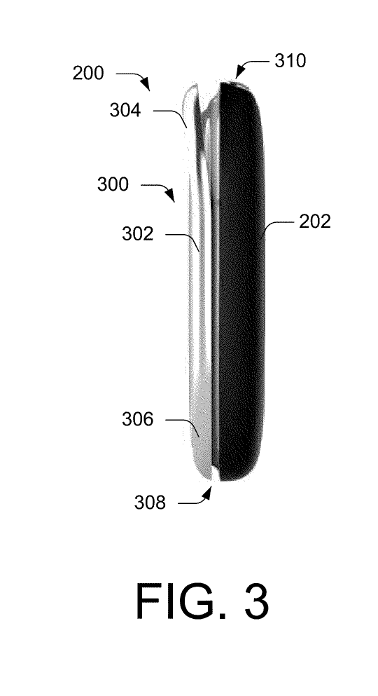

Moving on to FIGS. 2 and 3, consider the following. FIG. 2 illustrates an example camera device 200 in a front elevational view, while FIG. 3 illustrates the camera device 200 in a side elevational view. The camera device 200 includes a housing 202 that contains the components described in FIG. 1. Also illustrated is a camera lens 204 and I/O port 206 (FIG. 2) and a fastening device 300 (FIG. 3) in the form of a clip that operates in a manner that is similar to a clothespin. Specifically, the fastening device 300 includes a prong 302 with a body having a thumb-engageable portion 304. The body extends along an axis away from the thumb-engageable portion 304 toward a distal terminus 306. A spring mechanism, formed by the body or separate from and internal relative to the body, enables prong 302 to be opened responsive to pressure being applied to the thumb-engageable portion 304. When opened, a piece of clothing can be inserted into area 308. When the thumb-engageable portion 304 is released, the clothing is clamped in place by the prong 302 thereby securely mounting the camera device on a piece of clothing. For example, the camera device can be mounted, as described above, on a necktie, blouse, shirt, pocket, and the like.

In addition, camera device 200 can include a number of input buttons shown generally at 310. The input buttons can include, by way of example and not limitation, an input button to take a still picture, an input button to initiate the replay mode, an input button to initiate video capture, and an input button to enable the user to adjust the buffer size that is utilized during the replay mode. Alternately, a photo button can be provided in which a press of short duration takes a photo and a press of a longer duration initiates a photo log feature described below in more detail. Further, a video button can be provided in which a press of short duration starts/stops video capture and a press of longer duration initiates the replay mode. Alternately, these features can be merged into a single button with different actuation patterns to select the different features, e.g., short press, long press, double tap, triple tap, and the like. It is to be appreciated and understood that the various input buttons can be located anywhere on the camera device 200.

It may be noted that even though the camera device 200 is shown to have a particular shape, the camera device 100 can be manufactured in any shape shape and size suitable and sufficient to accommodate the above described components of the camera device 100. The housing 202 of the camera device may be made of a metal molding, a synthetic material molding or a combination thereof. In other embodiments, any suitable type of material may be used to provide a durable and strong outer shell for typical portable device use.

In addition, the fastening device 300 can comprise any suitable type of fastening device. For example, the fastening device may be a simple slip-on clip, a crocodile clip, a hook, a Velcro or a magnet or a piece of metal to receive a magnet. The camera device 200 may be affixed permanently or semi-permanently to another object using the fastening device 300.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the camera device 200 may include a computer-readable medium that may be configured to maintain instructions that cause the camera's software and associated hardware to perform operations. Thus, the instructions function to configure the camera's software and associated hardware to perform the operations and in this way result in transformation of the software and associated hardware to perform functions. The instructions may be provided by the computer-readable medium to the camera device through a variety of different configurations.

One such configuration of a computer-readable medium is signal bearing medium and thus is configured to transmit the instructions (e.g., as a carrier wave) to the camera device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Having considered an example operating environment in accordance with one or more embodiments, consider now a discussion of replay functionality and other features that can be provided by the camera device.

Replay Functionality

As noted above, camera device 200 includes a replay mode. When the replay mode is selected, as by the user pressing an input button associated with initiating the replay mode, the camera automatically captures image data, such as video or still images, and saves the image data to a memory buffer. In one or more embodiments, the memory buffer is a circular buffer that saves an amount of image data, for example video data. When the memory buffer is full of image data, it deletes the oldest image data to make room for newly recorded image data. This continues until either the user exits the replay mode or presses a button associated with initiating video capture, i.e. the “record” button.

In at least some embodiments, the size of the memory buffer can be set by the user to determine how much image data is to be collected. As an example, the user might set the length of the memory buffer to correspond to 5 seconds, 30 seconds, 1 minute, 2 minutes, and longer.

Assume now that an event occurs that the user wishes to memorialize through video or still images. Assume also that the user has initiated the replay mode so that video data is currently being buffered in the memory buffer. By pressing the “record” button the video data is now saved from the beginning of the memory buffer and recording continues until the user presses the record button again. In this manner, if an event occurs, the user is assured of capturing the event from a time t−x, where x is the length of the memory buffer, in time. So, for example, if the user initially set the memory buffer to capture 2 minutes worth of video data, by pressing the “record” button, the last 2 minutes of video data will be recorded in addition to video of the present-time up to the point that the user turns off video recording.

In one or more embodiments, the memory buffer comprises flash memory. When the user presses the “record” button and the camera device is in replay mode, a pointer is used to designate where, in flash memory, the beginning of the captured video data occurs, e.g., the beginning of the last 2 minutes of video data prior to entering the “record” mode. In other embodiments, the video data captured during replay mode and “record” mode can be written to an alternate storage location.

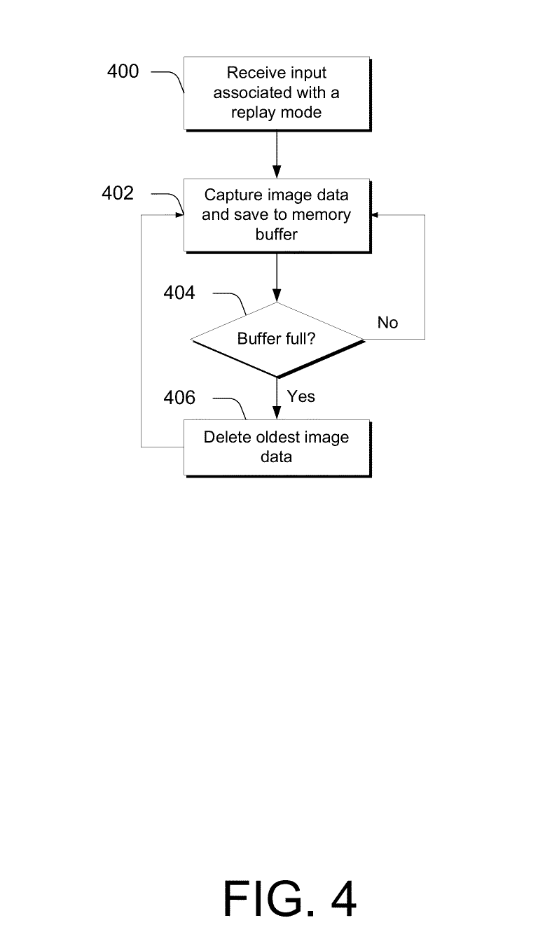

FIG. 4 is a flow diagram that describes steps in a method in accordance with one or more embodiments. The method can be performed in connection with any suitable hardware, software, firmware, or combination thereof. In at least some embodiments, the method is performed by a suitably-configured camera device such as the one described above.

Step 400 receives input associated with a replay mode. This step can be performed in any suitable way. For example, in at least some embodiments, this step can be performed by receiving input from the user via a suitable input device on the camera device. Responsive to receiving the input associated with the replay mode, step 402 captures image data and saves the image data to a memory buffer. Step 404 ascertains whether the buffer is full. If the buffer is not full, the method returns to step 402 and continues to capture image data and save image data to the memory buffer. If, on the other hand, the buffer is full, step 406 deletes the oldest image data in the memory buffer and returns to step 402 to capture subsequent image data.

This process continues until either the user presses the “record” button or exits the replay mode.

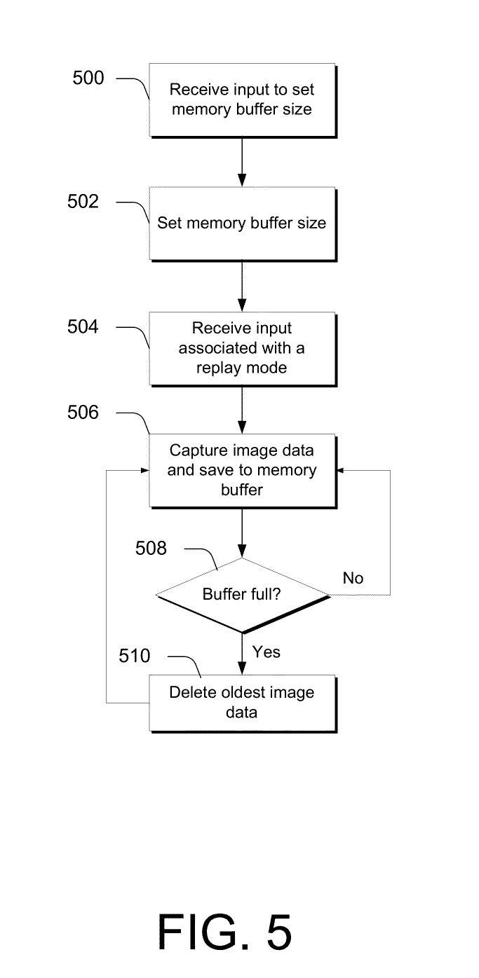

FIG. 5 is a flow diagram that describes steps in another method in accordance with one or more embodiments. The method, which allows a user to set the camera device's memory buffer size, can be performed in connection with any suitable hardware, software, firmware, or combination thereof. In at least some embodiments, the method is performed by a suitably-configured camera device such as the one described above.

Step 500 receives input to set a memory buffer size. The step can be performed in any suitable way. For example, in at least some embodiments, the step can be performed by receiving user input by way of a suitably-configured input mechanism such as a button on the camera device. Responsive to receiving this input, step 502 sets the memory buffer size.

Step 504 receives input associated with a replay mode. This step can be performed in any suitable way. For example, in at least some embodiments, this step can be performed by receiving input from the user via a suitable input device on the camera device. Responsive to receiving the input associated with the replay mode, step 506 captures image data and saves the image data to a memory buffer. Step 508 ascertains whether the buffer is full. If the buffer is not full, the method returns to step 506 and continues to capture image data and save image data to the memory buffer. If, on the other hand, the buffer is full, step 510 deletes the oldest image data in the memory buffer and returns to step 506 to capture subsequent image data.

This process continues until either the user presses the “record” button or exits the replay mode.

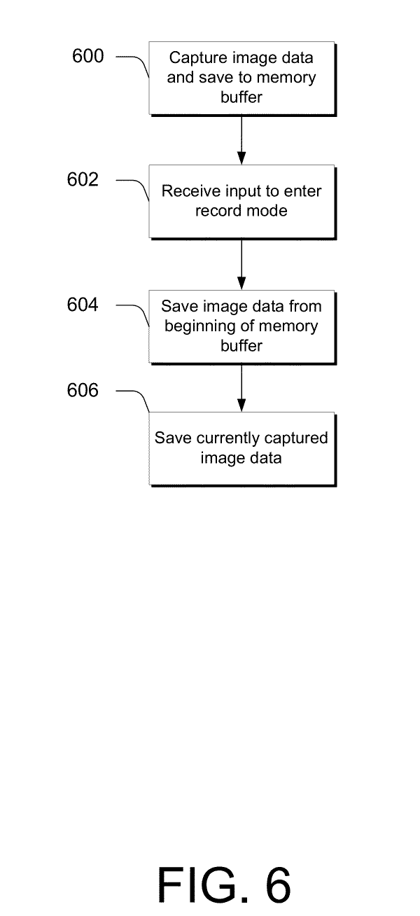

FIG. 6 is a flow diagram that describes steps of permanently saving content in accordance with one or more embodiments. The method can be performed in connection with any suitable hardware, software, firmware, or combination thereof. In at least some embodiments, the method is performed by a suitably-configured camera device such as the one described above.

Step 600 captures image data and saves the image data to a memory buffer. The step can be performed in any suitable way. For example, the step can be performed as described in connection with FIG. 4 or 5. Step 602 receives input to enter the camera device's record mode. This step can be performed, for example, by receiving user input by way of a “record” button. Responsive to receiving the input to enter record mode, step 604 saves image data from the beginning of the memory buffer. This step can be performed in any suitable way. For example, the step can be performed by setting a pointer to point to the beginning of the memory buffer. Step 606 saves currently captured image data in addition to the image data from the beginning of the memory buffer. This step can be performed until the user presses the “record” button once more.

Having considered an example replay mode and how it can be implemented with a suitably hiding configured camera device, consider now aspects of a dual encoding process.

Dual Encoding

In one or more embodiments, the camera device's processor 106 (FIG. 1) is configured to encode image data at different levels of resolution. For example, the camera device can encode image data at a low level of resolution and at a high level of resolution as well. Any suitable levels of resolution can be utilized. In at least some embodiments, the low level of resolution is Quarter-VGA (e.g., 320×240) and the high level of resolution is720p (e.g., 1280×720).

Encoding image data at different resolutions levels can enhance the user's experience insofar as giving the user various options to transfer the saved image data. For example, at lower resolution levels, the captured image data can be streamed to a device such as a smart phone. Alternately or additionally, at higher resolution levels, when the user has Wi-Fi accessibility, they can transfer the image data to a network device such as a laptop or desktop computer.

Having considered a dual encoding scenario, consider now aspects of a photo log that can be constructed using the principles described above.

Photo Log

Photo log refers to a feature that enables a user to log their day in still photos at intervals of their own choosing. So, for example, if the user wishes to photo log their day at every 3 minutes, they can provide input to the camera device so that every 3 minutes the camera takes a still photo and saves it. At the end of the day, the user will have documented their day with a number of different still photos.

In at least some embodiments, the photo log feature can work in concert with the replay mode described above. For example, if the user has entered the replay mode by causing image data to be captured and saved to the memory buffer, the camera device's processor can process portions of the captured video data at defined intervals to provide the still photos. This can be performed in any suitable way. For example, the camera device's processor can process the video data on the camera's photosensor and read predefined areas of the photosensor to process the read areas into the still photos. In some instances the photo format is a square format so that the aspect ratio is different from that aspect ratio of the video data.

Having considered various camera embodiments, consider now a discussion of a portable camera dock.

Portable Camera Dock

Various embodiments provide a portable camera dock that is configured to receive a camera. The portable camera dock can enable data to be transferred between the camera and another device connected to the portable camera dock. Alternately or additionally, the portable camera dock can enable the camera to be recharged.

The portable camera dock includes electronic structure to enable functional connections between a suitably-configured camera and the portable camera dock. The electronic structure can serve to enable one or both of information transfer to and from the camera, and recharging of the camera. Further, the portable camera dock can include mounting structure to enable the portable camera dock to be mounted to other structures to facilitate portability of a camera docked to the camera dock.

The portable camera dock is designed in such a way so as to ease the transition between a camera's “plugged in” state (e.g., for information transfer or recharging) and a wireless state in which the camera is not plugged in to another device.

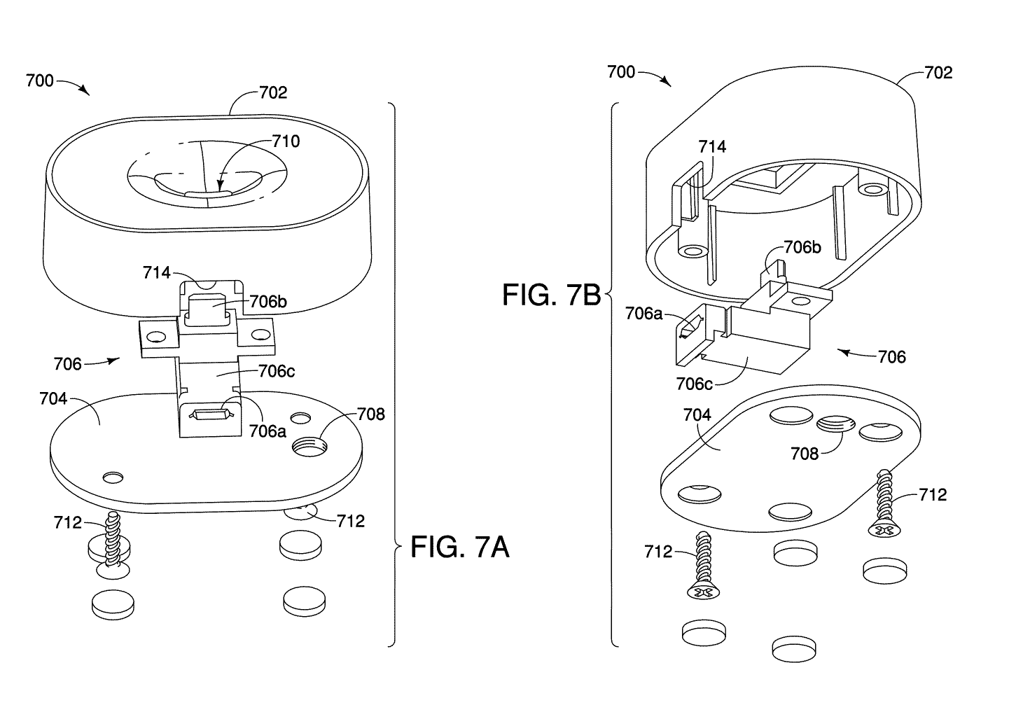

FIGS. 7A and 7B illustrate an example portable camera dock in accordance with one embodiment, generally at 700. The portable camera dock includes a top housing 702, a bottom 704, electronic structure 706 and mounting structure 708. The portable camera dock can be formed from any suitable type of material. In this particular example, the top housing comprises injection molded plastic that is configured to receive a camera to enable a functional connection with electronic structure 706. Specifically, top housing 702 includes an aperture 710 through which the electronic structure 706 can make a connection with the camera's I/O port. Bottom 704 can be formed from any suitable type of material. In this particular example, bottom 704 is formed from a steel plate that is mounted to top housing 702 by way of a pair of screws 712. Also provided are four plugs (not specifically labeled) which fit into apertures underneath the bottom 704 to provide traction on a surface onto which the portable camera dock may be placed.

Electronic structure 706 can comprise any suitable type of electronic structure that can enable functional connection to the camera as described above and below. In this particular example, electronic structure 706 includes a micro-USB male-to-female adapter and a single over-mold support structure supporting the USB adapter. Specifically, the USB male-to-female adapter includes a female portion 706a and a male portion 706b. The male and female portions are supported by support structure 706c which enables electronic structure 706 to be firmly mounted within the portable camera dock 700. Specifically, when the bottom 704 is mounted to the top housing 702, the USB male portion 706b extends through aperture 710 to enable a functional connection with the camera. Similarly, the USB female portion 706a can be accessed by an external cable through a recess 714 in the top housing portion 702. The external cable can be used to connect the camera, by way of the portable camera dock, to an external computing device as discussed above. This can permit information and data exchange between the camera and external computing device. Alternately or additionally, this can permit the camera to be recharged.

Mounting structure 708 is configured to enable the portable camera dock to be mounted to other structures to facilitate portability of a camera docked to the camera dock. Any suitable type of mounting structure can be utilized including, by way of example and not limitation, mechanical structures, magnetic structures, electromagnetic structures, and the like. Further, in at least some embodiments, the mounting structure 708 can serve to provide functionality in addition to enabling the portable camera dock to be mounted on other structures. For example, the mounting structure 708 can also serve a dual purpose as enabling a functional connection to the camera to enable such things as data exchange and recharging.

In the illustrated and described embodiment, the mounting structure 708 comprises a screw mount that serves as a receptacle into which a screw connection can be made to another structure. Any other suitably-configured structure can be connected to the mounting structure 708 including, by way of example and not limitation, a tripod mount, a helmet mount, a mount on a motor vehicle or other conveyance, and the like.

The portable camera dock, by virtue of its electronic structure 706 and the way that it is positioned inside the camera dock, avoids the situation of having electronic cable permanently extending out of the dock. That is, in at least some embodiments, the portable camera dock does not have a cable extending out of the dock. This serves to promote portability by making it much easier for a user to disconnect the portable camera dock from a computing device and move it to another location in the “wireless” mode. For example, assume that a user has recharged their camera and now wishes to record a video of themselves in the kitchen trying out a new recipe. In this case, the user would simply disconnect an extra cable from female USB portion 706a and move both the portable camera dock and a camera mounted thereon to a new location. The user can now set the portable camera dock on the counter to record their culinary activities.

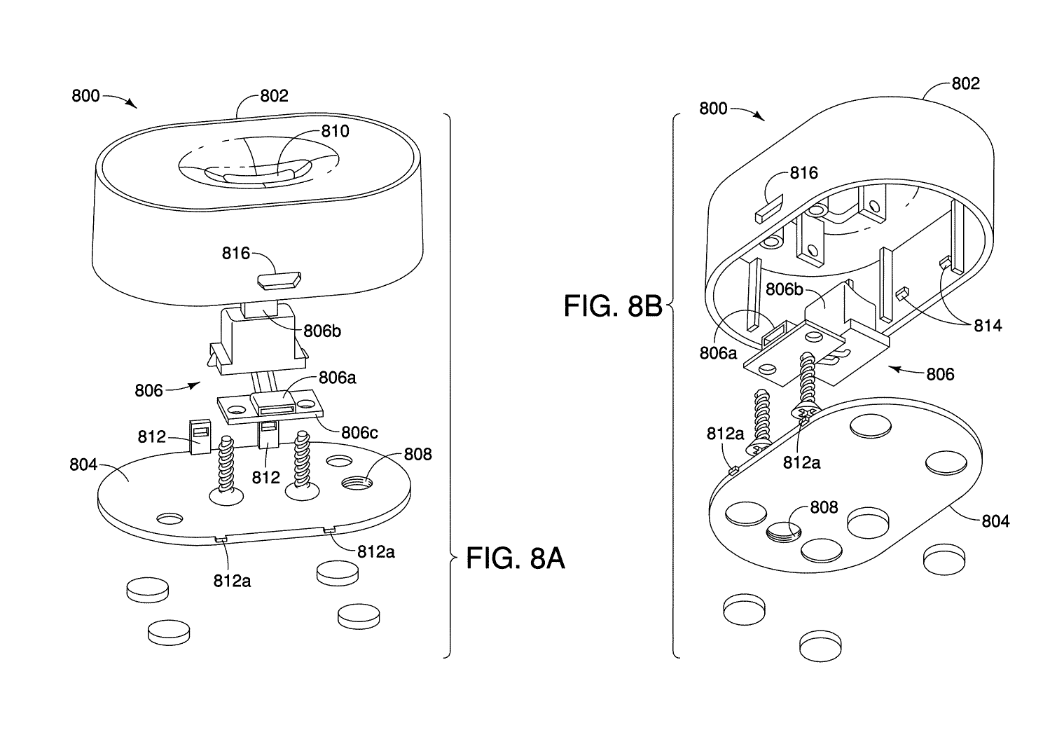

FIGS. 8A and 8B illustrate an example portable camera dock in accordance with one embodiment, generally at 800. The portable camera dock includes a top housing 802, a bottom 804, electronic structure 806 and mounting structure 808. The portable camera dock can be formed from any suitable type of material. In this particular example, the top housing comprises injection molded plastic that is configured to receive a camera to enable a functional connection with electronic structure 806. Specifically, top housing 802 includes an aperture 810 through which the electronic structure 806 can make a connection with the camera's I/O port. Bottom 804 can be formed from any suitable type of material. In this particular example, bottom 804 is formed from injection molded plastic that is mounted to top housing 802 by way of a snap fit. Specifically, bottom 804 includes a pair of extension arms 812 each of which includes an aperture. The bottom also includes a pair of detents 812a which fit into complementary-formed apertures in the top housing 802. When the bottom 804 is snapped into place, the extension arms 812 are guided along the interior wall of the top housing 802 until a pair of detents 814 on the interior wall of the top housing are received in the corresponding apertures of the extension arms 812. Also provided are four plugs (not specifically labeled) which fit into apertures underneath the bottom 804 to provide traction on a surface onto which the portable camera dock may be placed.

Electronic structure 806 can comprise any suitable type of electronic structure that can enable functional connection to the camera as described above and below. In this particular example, electronic structure 806 includes a cable assembly that includes a USB female portion 806a, a USB male portion 806b, a printed circuit board (PCB) 806c operably mounted to USB female portion 806a and interconnecting cables that connect with the USB male portion 806b. The PCB 806c is mounted to the housing interior by way of two screws (not specifically designated). When the bottom 804 is mounted to the top housing 802, the USB male portion 806b extends through aperture 810 to enable a functional connection with the camera. Similarly, the USB female portion 806a can be accessed by an external cable through an aperture 816 in the top housing portion 802. The external cable can be used to connect the camera, by way of the portable camera dock, to an external computing device as discussed above. This can permit information and data exchange between the camera and external computing device. Alternately or additionally, this can permit the camera to be recharged.

Mounting structure 808 is configured to enable the portable camera dock to be mounted to other structures to facilitate portability of a camera docked to the camera dock. Any suitable type of mounting structure can be utilized, examples of which are provided above. For the sake of brevity, these examples are not repeated here.

Like in the above example, the portable camera dock, by virtue of its electronic structure 806, avoids the situation of having an electronic cable permanently extending out of the dock. This serves to promote portability by making it much easier for a user to disconnect the portable camera dock from a computing device and move it to another location in the “wireless” mode.

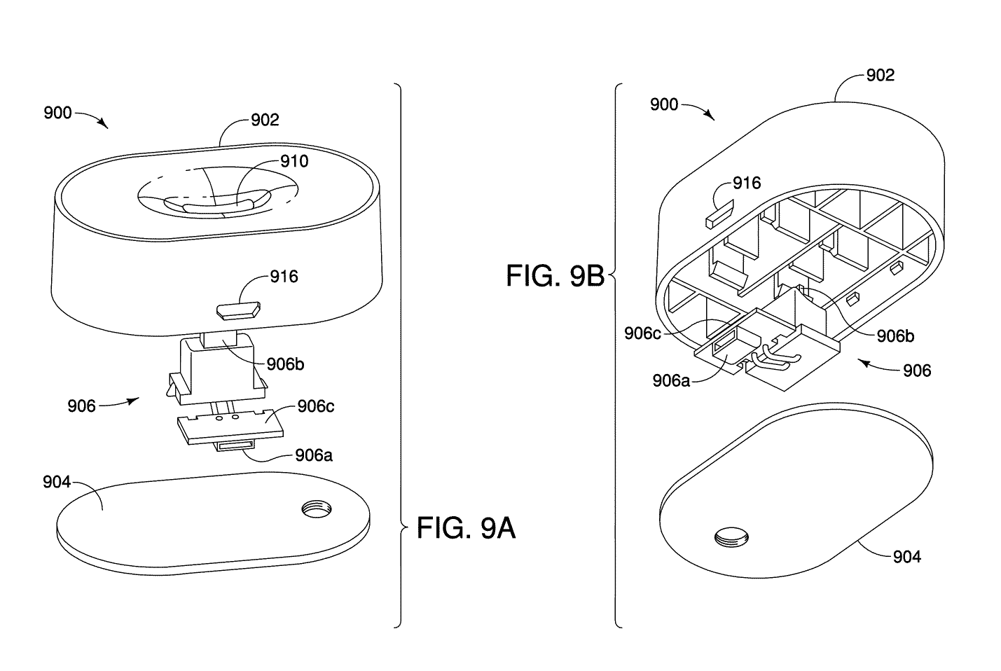

FIGS. 9A and 9B illustrate an example portable camera dock in accordance with one embodiment, generally at 900. The portable camera dock includes a top housing 902, a bottom 904, electronic structure 906 and mounting structure 908. The portable camera dock can be formed from any suitable type of material. In this particular example, the top housing comprises injection molded plastic that is configured to receive a camera to enable a functional connection with electronic structure 906. Specifically, top housing 902 includes an aperture 910 through which the electronic structure 906 can make a connection with the camera's I/O port. Bottom 904 can be formed from any suitable type of material. In this particular example, bottom 904 is formed from a hard, rubberized pad that is adhesively mounted to the top housing 902.

Electronic structure 906 can comprise any suitable type of electronic structure that can enable functional connection to the camera as described above and below. In this particular example, electronic structure 906 includes a cable assembly that includes a USB female portion 906a, a USB male portion 906b, a printed circuit board (PCB) 906c operably mounted to USB female portion 906a and interconnecting cables that connect with the USB male portion 906b. The PCB 906c is mounted to the housing interior by way of a snap fit between the carriage carrying USB male portion 906b and the underside of the top housing 902.

When the bottom 904 is mounted to the top housing 902, the USB male portion 906b extends through aperture 910 to enable a functional connection with the camera. Similarly, the USB female portion 906a can be accessed by an external cable through an aperture 916 in the top housing portion 902. The external cable can be used to connect the camera, by way of the portable camera dock, to an external computing device as discussed above. This can permit information and data exchange between the camera and an external computing device. Alternately or additionally, this can permit the camera to be recharged.

Mounting structure 908 is configured to enable the portable camera dock to be mounted to other structures to facilitate portability of a camera docked to the camera dock. Any suitable type of mounting structure can be utilized, examples of which are provided above. For the sake of brevity, these examples are not repeated here.

Like in the above example, the portable camera dock, by virtue of its electronic structure 906, avoids the situation of having an electronic cable permanently extending out of the dock. This serves to promote portability by making it much easier for a user to disconnect the portable camera dock from a computing device and move it to another location in the “wireless” mode.

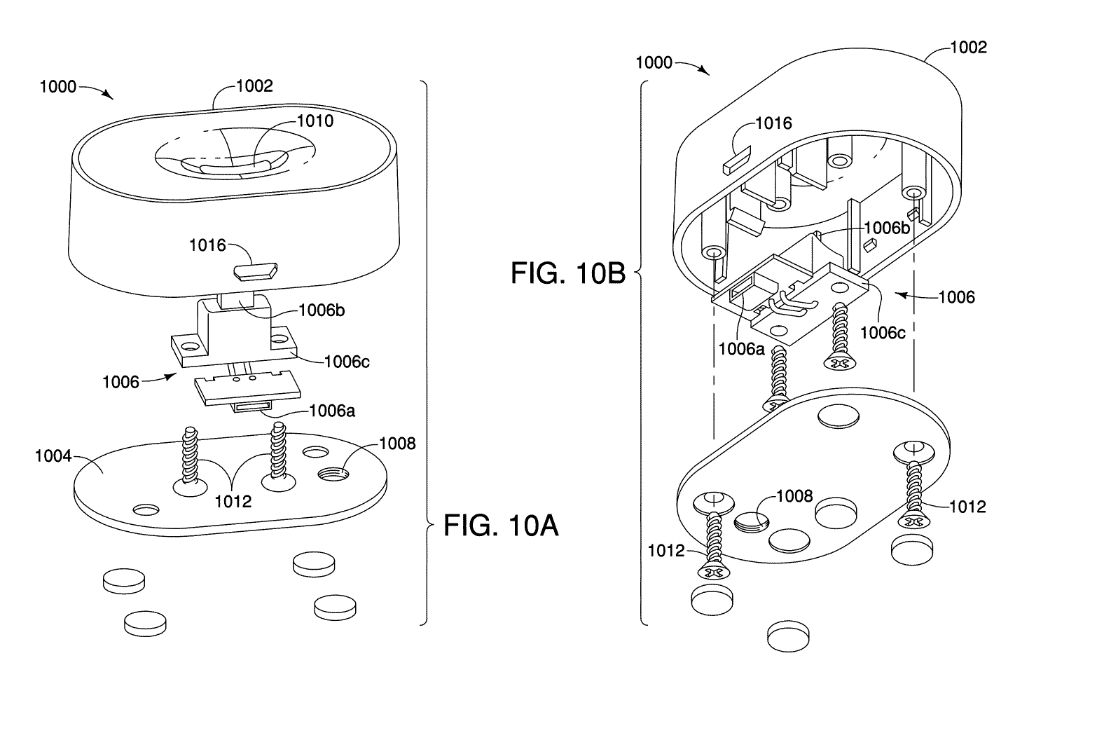

FIGS. 10A and 10B illustrate an example portable camera dock in accordance with one embodiment, generally at 1000. The portable camera dock includes a top housing 1002, a bottom 1004, electronic structure 1006 and mounting structure 1008. The portable camera dock can be formed from any suitable type of material. In this particular example, the top housing comprises injection molded plastic that is configured to receive a camera to enable a functional connection with electronic structure 1006. Specifically, top housing 1002 includes an aperture 1010 through which the electronic structure 1006 can make a connection with the camera's I/O port. Bottom 1004 can be formed from any suitable type of material. In this particular example, bottom 1004 is formed from a steel plate that is mounted to top housing 1002 by way of a pair of screws 1012. Also provided are four plugs (not specifically labeled) which fit into apertures underneath the bottom 1004 to provide traction on a surface onto which the portable camera dock may be placed.

Electronic structure 1006 can comprise any suitable type of electronic structure that can enable functional connection to the camera as described above and below. In this particular example, electronic structure 1006 includes a cable assembly that includes a USB female portion 1006a, a USB male portion 1006b, a printed circuit board (PCB) 1006c operably mounted to USB female portion 1006a and interconnecting cables that connect with the USB male portion 1006b. The PCB 1006c is mounted to the housing interior by way of two clips which clip into the underside of the top housing 1002 (not specifically designated). The electronic structure is mounted to the interior by way of two screws that extend through the carriage carrying the USB male portion 1006b.

When the bottom 1004 is mounted to the top housing 1002, the USB male portion 1006b extends through aperture 1010 to enable a functional connection with the camera. Similarly, the USB female portion 1006a can be accessed by an external cable through an aperture 1016 in the top housing portion 1002. The external cable can be used to connect the camera, by way of the portable camera dock, to an external computing device as discussed above. This can permit information and data exchange between the camera and external computing device. Alternately or additionally, this can permit the camera to be recharged.

Mounting structure 1008 is configured to enable the portable camera dock to be mounted to other structures to facilitate portability of a camera docked to the camera dock. Any suitable type of mounting structure can be utilized, examples of which are provided above. For the sake of brevity, these examples are not repeated here.

Like in the above example, the portable camera dock, by virtue of its electronic structure 1006, avoids the situation of having an electronic cable permanently extending out of the dock. This serves to promote portability by making it much easier for a user to disconnect the portable camera dock from a computing device and move it to another location in the “wireless” mode.

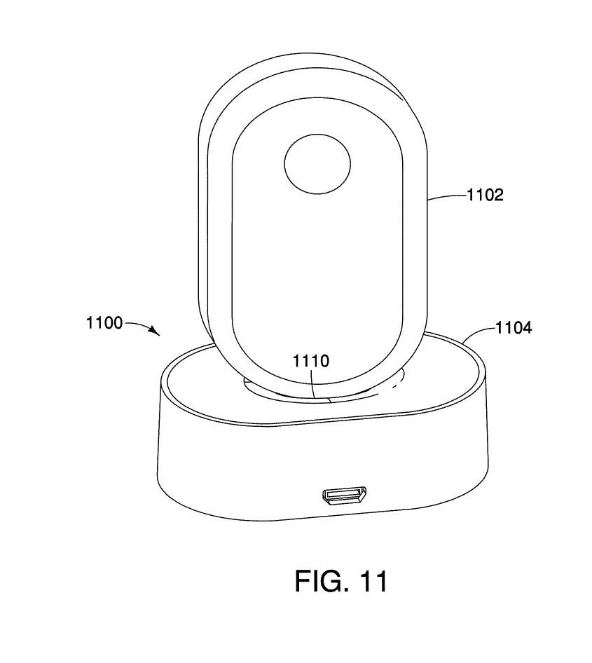

FIG. 11 shows an assembly 1100 with a camera 1102 docked to a portable camera dock 1104 by way of an aperture designated generally at 1110.

### CONCLUSION

Various embodiments provide a portable camera dock that is configured to receive a camera. The portable camera dock can enable data to be transferred between the camera and another device connected to the portable camera dock. Alternately or additionally, the portable camera dock can enable the camera to be recharged.

The portable camera dock includes electronic structure to enable functional connections between a suitably-configured camera and the portable camera dock. The electronic structure can serve to enable one or both of information transfer to and from the camera, and recharging of the camera. Further, the portable camera dock can include mounting structure to enable the portable camera dock to be mounted to other structures to facilitate portability of a camera docked to the camera dock.

The portable camera dock is designed in such a way so as to ease the transition between a camera's “plugged in” state (e.g., for information transfer or recharging) and a wireless state in which the camera is not plugged in to another device.

Although the embodiments have been described in language specific to structural features and/or methodological acts, it is to be understood that the various embodiments defined in the appended claims are not necessarily limited to the specific features or acts described. Rather, the specific features and acts are disclosed as example forms of implementing the various embodiments.

What is claimed is:

1. A camera dock comprising:
a top housing;
a bottom connected to the top housing;
electronic structure mounted inside the top housing and configured to enable a functional connection to a camera, the functional connection enabling one or more of: data to be transferred between the camera and another device, or the camera to be recharged; and
mounting structure on the camera dock configured to enable the camera dock to be mounted to another structure.

2. The camera dock of claim 1, wherein the electronic structure comprises a USB male-to-female adapter.

3. The camera dock of claim 1, wherein the mounting structure is disposed on the bottom.

4. The camera dock of claim 1, wherein the mounting structure comprises a mechanical structure.

5. The camera dock of claim 1, wherein the mounting structure comprises a screw mount.

6. The camera dock of claim 1, wherein the portable camera dock does not have a cable extending out of the portable camera dock.

7. The camera dock of claim 1, wherein the bottom is screw-mounted to the top housing.

8. A system comprising:
a camera; and
a camera dock comprising:
a top housing;
a bottom connected to the top housing;
electronic structure mounted inside the top housing and configured to enable a functional connection to the camera, the functional connection enabling one or more of: data to be transferred between the camera and another device, or the camera to be recharged; and
mounting structure on the camera dock configured to enable the camera dock to be mounted to another structure.

9. The system of claim 8, wherein the electronic structure comprises a USB male-to-female adapter.

10. The system of claim 8, wherein the mounting structure is disposed on the bottom.

11. The system of claim 8, wherein the mounting structure comprises a mechanical structure.

12. The system of claim 8, wherein the mounting structure comprises a screw mount.

13. The system of claim 8, wherein the portable camera dock does not have a cable extending out of the portable camera dock.

14. The system of claim 8, wherein the bottom is screw-mounted to the top housing.

15. The system of claim 8, wherein the camera comprises a wearable camera that is configured to be worn by a user.

16. The system of claim 8, wherein the camera comprises a wearable camera that is configured to be worn by a user on clothing.

17. A camera dock comprising:
a top housing having an aperture;
a bottom connected to the top housing;
electronic structure mounted inside the top housing and configured to enable a functional connection to a camera through the aperture in the top housing, the functional connection enabling one or more of: data to be transferred between the camera and another device, or the camera to be recharged; and
a mechanical mounting structure on the bottom and configured to enable the camera dock to be mounted to another structure.

18. The camera dock of claim 17, wherein the electronic structure comprises a USB male-to-female adapter having a male portion that extends through the aperture.

19. The camera dock of claim 17, wherein the mounting structure comprises a screw mount.

20. The camera dock of claim 17 further comprising a camera configured to be mounted on the top housing.
